(19) United States
(12) Patent Application Publication
(10) Pub. No.: US 2022/0388748 A1
(43) Pub. Date: Dec. 8, 2022

(54) THERMOFORMABLE FILM FOR BARRIER PACKAGING AND METHODS OF FORMING THE SAME

(71) Applicant: KLÖCKNER PENTAPLAST OF AMERICA, INC., Gordonsville, VA (US)

(72) Inventors: Wade Jackson KAMMAUFF, Charlottesville, VA (US); Seth Thomas STEWART, Charlottesville, VA (US); Norman AMINUDDIN, Crozet, VA (US)

(21) Appl. No.: 17/828,744

(22) Filed: May 31, 2022

Related U.S. Application Data
(60) Provisional application No. 63/195,503, filed on Jun. 1, 2021.

(51) Int. Cl. B65D 75/32; B29C 51/00; B29C 51/14; B32B 27/08; B32B 27/32; C08J 5/18; C08F 210/02; C08F 232/08

(52) U.S. Cl. CPC B65D 75/327; B29C 51/002; B29C 51/14; B32B 27/08; B32B 27/32; C08J 5/18; C08F 210/02; C08F 232/08; B29L 2031/7164

(57) ABSTRACT

In various aspects, the present disclosure pertains to thermoformable, multi-layer polymer films comprising a core layer that is comprised of a blend of high density polyethylene and low density polyethylene and, at least one outermost layer that is comprised of a blend of a cyclic olefin copolymer, polyethylene, a functionalized polymer, a dispersing agent and a mineral filler. The present disclosure includes thermoformed webs made from such films, the webs having one or more thermoformed cavities contained therein. Other aspects of the disclosure pertain to methods of forming such thermoformed webs, packaged products comprising such thermoformed webs, and methods of recycling such thermoformed webs.

### CROSS-REFERENCE TO RELATED APPLICATIONS

This application claims the benefit of pending U.S. provisional patent application No. 63/195,503, filed Jun. 1, 2021, entitled “THERMOFORMABLE BARRIER PACKAGING AND METHODS OF FORMING THE SAME,” the entirety of which application is incorporated by reference herein.

### BACKGROUND

Thermoformed packaging is commonly used for the packaging of consumable products including pharmaceuticals, food products, and chewing gum, as well as medical devices, among others. Blister packaging is a particular form of thermoformed packaging that serves important societal needs. For example, blister packaging is particularly useful for pharmaceuticals because it ensures a sterile environment for each dose and helps protect the packaged drugs from degradation and physical damage which maintains the efficacy of the drugs. Blister packaging with enhanced barrier properties that is a drop-in replacement for standard thermoforming films is particularly useful for pharmaceuticals that are susceptible to environmental degradation such as moisture and oxygen. Blister packaging can also keep multiple dose forms from adhering to one another and is aesthetically pleasing. The format of the blister package, where dosage forms can be individually packaged and are visible, further provides a psychological benefit, as studies have shown that patients comply with prescription instructions better and complete their prescribed dose when the dosage forms are packaged in blisters as opposed to being placed in vials. Thermoformed packaging with enhanced barrier properties has also proven to be a growing need in the medical device market as it ensures a sterile environment for the medical device(s) that are packaged therein, helps protect the packaged medical device(s) from physical damage, protects against environmental degradation of sensitive components, and provides a convenient kit format to assist in organizing the medical procedure being performed.

Moreover, as the consumption of plastic increases worldwide the ability to recycle packaging is also a societal need and conventional blister packages do not fulfill this requirement. Blister packaging and medical device packaging are mature technologies that have traditionally used PVC film and its various laminates. To achieve the desired barrier properties for blister packages, PVC is typically either coated with PVDC or laminated to PCTFE to create a thermoformable barrier solution. Since the strategy of coating or laminating barrier materials to PVC requires combining different polymers in the film structure, this strategy inherently provides challenges for recycling because of the difficulty separating different types of polymers. PVC-based films are easily thermoformed, have a sharp softening point, can be made with low residual shrinkage, and cut easily. Blister and medical device packaging machines were designed specifically for these attributes. Thus, the large infrastructure of machines which exists today are suitable for films with PVC-like performance attributes. Although PVC is recyclable as a mono-film, the addition of barrier polymers through lamination or coating renders the multilayer film structure non-recyclable due to the difficulties in separating the various polymer layers. These multilayer structures cause the PVC that typically has a Resin Identification Code (RIC) #3 (PVC) material to be classified as an RIC #7 (Other) material instead, resulting in the articles generally ending up landfilled.

There is a need for a non-PVC film having properties equivalent to pharmaceutical barrier film which can run on existing machine lines at standard PVC cycle times. There is also a need for a non-PVC film having properties equivalent to pharmaceutical barrier film which can be recycled in traditional mechanical recycling streams. One such recycling stream, known as ASTM International Resin Identification Coding System (RIC) stream #2 (RIC 2), applies to products that contain High-Density Polyethylene (HDPE). However, standard or neat HDPE films are not ideal for use in pharmaceutical blister packages and medical device packages due to the high shrinkage rates and narrow thermoforming window associated with HDPE films.

### SUMMARY

In various aspects, the present disclosure pertains to thermoformable, multi-layer films that may be thermoformed into webs having one or more thermoformed cavities contained therein.

In some embodiments, the thermoformable, multi-layer polymer film comprises a structure of at least two layers produced through either coextrusion or lamination of a core layer and one or more outermost (skin) layers. In some embodiments, the multi-layer polymer film comprises a core layer disposed between two outermost layers.

In some embodiments, the thermoformable film is characterized by a moisture vapor permeation rate below about 350 g·μm/m²/day at 40° C. and 75% relative humidity, preferably below about 140 g·μm/m²/day at 40° C. and 75% relative humidity, and more preferably less than about 105 g·μm/m²/day at 40° C. and 75% relative humidity as measured using the method set forth in ASTM D-1249.

In some embodiments, the thermoformable film is characterized by an overall density of less than or equal to about 1.0 g/cm³, typically ranging between 0.900 g/cm³ and 0.999 g/cm³.

In some embodiments, a core layer of the thermoformable film comprises between about 40% to 80% of the thickness of the film.

In some embodiments, a core layer of the thermoformable film comprises a blend of polyolefin resins, for example, a blend of a high density polyethylene (HDPE) having melt flow index (MFI) greater than about 0.1 g/10 min and less than about 30 g/10 min and a low density polyethylene (LDPE), having MFI greater than about 0.1 g/10 min and less than about 30 g/10 min.

In some embodiments, a core layer of the thermoformable film is formed from a polymer blend that comprises (a) about 50 wt % to 95 wt % HDPE, more typically about 70 wt % to 90 wt % HDPE, and (b) about 5 wt % to 50 wt %, more typically from 10 wt % to 30 wt % LDPE. In some embodiment, the combined amount of HDPE and LDPE ranges from 95% to 100% of the total weight of the core, typically 100% of the total weight of the core. In some embodiments, the total content of the polyethylene in the multi-layer polymer film is greater than 50% of the total weight of the multi-layer polymer film, more typically ranging between 55% and 75% of the total weight of the multi-layer polymer film.

In some embodiments, one or more outermost layers of the thermoformable film are comprised of a blend of polyethylene (e.g., HDPE, LDPE, or both), functionalized polymers (e.g., functionalized HDPE, functionalized LDPE, or both, acrylate copolymer), a cyclic olefin copolymer such as ethylene norbornene copolymer or ethylene tetracyclododecene copolymer, at least one mineral filler including but not limited to kaolin, talc, or other phyllosilicate clays, or calcium carbonate, and at least one dispersing agent such as, for example, liquid and/or solid processing aid, more specifically modified or unmodified polyolefin waxes. In some embodiments, the copolymer of norbornene and ethylene has a glass transition temperature ranging from 70 to 140° C. as measured by DSC. In some embodiments, the copolymer of norbornene and ethylene comprises less than 40% of the total mass of the multi-layer polymer film. In some embodiments, the mineral fillers are finely dispersed in the polymer matrix resulting in improved thermal and mechanical properties.

In some embodiments, one or more outermost layers of the thermoformable film are formed from a polymer blend that comprises (a) about 60 wt % to 90 wt % of a cyclic olefin copolymer, (b) about 0 wt % to 25 wt % of a polyethylene, (c) about 0.5 wt % to 30 wt % of the functionalized polymers, (d) about 0.1 wt % to about 15 wt % of a mineral filler, and (e) about 0 wt % to 15 wt % of the dispersing agent.

In some embodiments, the thermoformable, multi-layer film has a thermoforming range of 90° C. to 150° C., more preferably 100° C. to 135° C. as measured on an unsupported web thermoforming machine.

In some embodiments, the thermoformable, multi-layer film has a crystalline melting temperature between 100° C. and 150° C. as measured by DSC.

In some embodiments, the thermoformable, multi-layer polymer ranges from 25 microns to 2000 microns in overall thickness.

In some embodiments, the thermoformable, multi-layer polymer film is formed by extruding two or more polymer blends in a sheet having two or more layers.

In some embodiments, the thermoformable, multi-layer film is a blown film, a cast film, an extrusion coated film, a co-extruded film, a laminated, or a calendered film.

In some embodiments, the thermoformable, multi-layer film meets the floating criteria set forth in Association of Plastic Recyclers (APR) Document Code HDPE-CG-01.

In various aspects, the present disclosure pertains to methods of forming thermoformed webs from thermoformable, multi-layer films in accordance with the above aspects and embodiments, which methods comprise heating the thermoformable, multi-layer film to a temperature whereby a softened polymer film is formed and forcing the softened film into one or more cavities of a mold. In some embodiments, the methods include heating the thermoformable, multi-layer film to a temperature ranging from about 100° C. to 135° C. In some embodiments, the thermoformed web is formed on an unsupported machine and the thermoformable, multi-layer film has a maximum shrinkage during processing in a range of +/−8%, preferably +/−5%, in any direction.

In various aspects, the present disclosure pertains to packaged products comprising (a) a thermoformed web in accordance with the above aspects and embodiments, (b) lidding applied to the thermoformed web, and (c) one or more products positioned in the one or more thermoformed cavities and between the lidding and the thermoformed web. In some embodiments, the packaged products are consumable products. In some of these embodiments, the lidding comprises a rupturable layer and a burst resistant layer that can be removed from the rupturable layer, a rupturable layer that can be opened by pressure on an opposite side of the packaged product, or a peelable layer that can be removed from the thermoformed web giving access to the one or more products. In some of these embodiments, the lidding comprises a polymer and/or paper. In some embodiments, the packaged products comprise a medical device. In some embodiments, a thickness of the film used in the packaged products ranges from about 25 to 2000 microns, preferably about 40 to 550 microns.

In various aspects, the present disclosure pertains to processes of forming a packaged product in accordance with any of above aspects embodiments, which comprise (a) positioning the one or more products in one or more thermoformed cavities of the thermoformed web and (b) sealing lidding to the thermoformed web thereby enclosing the one or more products in the one or more thermoformed cavities. In some embodiments, the lidding is sealed to the thermoformed web at a machine sealing temperature ranging from 90 to 160° C.

### BRIEF DESCRIPTION OF THE DRAWINGS

FIG. 1 is a schematic illustration of a blister package that includes a thermoformed web containing an array of thermoformed cavities, known as blisters, which contain a consumable product of interest, in accordance with an embodiment of the present disclosure.

FIG. 2 is a schematic illustration of a medical device package that includes a thermoformed web containing one or more thermoformed cavities, which contain one or medical devices, in accordance with an embodiment of the present disclosure.

FIG. 3 is a graphical illustration of transverse direction shrinkage versus thermoforming temperature of multi-layer polymer films, in accordance with embodiments of the present disclosure.

### DETAILED DESCRIPTION

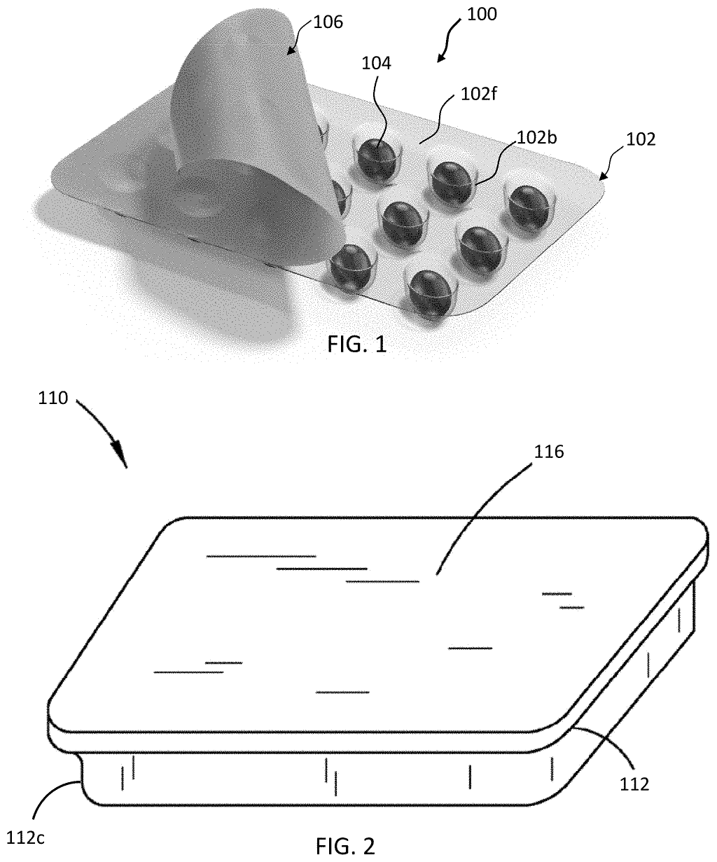

With reference now to FIG. 1, a blister package 100 typically includes a multi-layer polymer film 102 containing an array of thermoformed cavities, known as blisters 102b, which contain a consumable product 104 of interest (e.g., pharmaceutical dosage forms, food products, chewing gums, etc.) and onto which a cover 106, also known as a lidding, is applied. The lidding 106 can be formed from one or more materials known in the art such as foils, polymer films and/or paper. The lidding 106 is generally scaled to the flat portion 102f of the multi-layer polymer film 102 that remains as a sealing-area outside and between the blisters 102b, often with a heat seal lacquer or polymeric seal layer. In embodiments, the polymeric seal layer is a layer of film laminated or coextruded with the lidding film for the purpose of sealing to the thermoformed web.

During thermoforming, the multi-layer polymer film 102 is heated to a softening temperature and blisters 102b of a given shape are thermoformed across the film. The resulting product (i.e., the multi-layer polymer film 102 with blister cavities 102b formed therein), is also referred to herein as a thermoformed web.

Most blister packaging machines use heat and gas pressure (with or without plug assist) to form blisters in a multi-layer polymer film obtained from a roll or in the form of a sheet. In a typical process, a multi-layer polymer film is unwound from a roll and guided through the blister packaging machine. The multi-layer polymer film passes through contact heaters (or radiant heaters) to reach an elevated temperature such that the multi-layer polymer film will soften and become pliable. The softened polymer film is then blown into cavities in a mold by using a pressurized gas (e.g., compressed air, etc.), with or without plug assist, which will form blisters in the multi-layer polymer film, thus creating a thermoformed web. The mold is typically cooled such that the multi-layer polymer film becomes sufficiently rigid so that the thermoformed web maintains its shape, allowing the thermoformed web to be removed from the mold. (Other processes are known as well, including processes in which blisters are formed by drawing the multi-layer polymer film into cavities of a forming tool via a vacuum, after the multi-layer polymer film is heated and softened, with or without plug assist.) Blister packaging machines are commonly unsupported web machines, meaning that the multi-layer polymer film is pulled through the machine without the sides of the film being supported. A filling device is then used to place the desired product into the blisters. Subsequently, a sealing station is used to seal the lidding onto the surface of the thermoformed web at a suitable temperature and pressure, which seals the desired product in the blisters. Multi-layer polymer film thicknesses for processing into blister packaging machines typically range from 40 microns or less to 550 microns or more, for example ranging from 25 to 40 to 100 to 150 to 200 to 250 to 300 to 350 to 400 to 450 to 500 to 550 to 600 to 650 to 700 to 750 to 800 to 850 to 900 to 950 to 1000 to 1050 to 1100 to 1150 to 1200 to 1250 to 1300 to 1350 to 1400 to 1450 to 1500 to 1550 to 1600 to 1650 to 1700 to 1750 to 1800 to 1850 to 1900 to 1950 to 2000 microns (in other words, ranging between any two of the preceding values).

With reference now to FIG. 2, a medical device package 110 commonly includes a multi-layer polymer film 112 containing one or more thermoformed cavities 112c, which contain, for example, one or more medical devices, medical device components, and/or medical device accessories, and onto which a cover 116, also known as lidding is applied. The lidding 116 can be formed from one or more materials known in the medical device packaging art, for example, polymeric lidding materials such as TYVEK® (a spun bonded material formed from high-density polyethylene fibers, DuPont Safety & Construction, Inc., Wilmington, Del.) and/or paper. The lidding 116 is generally scaled to the flat portion of the multi-layer polymer film 112 that remains as a sealing-area outside the one or more thermoformed cavities 112c (as well as between the one or more thermoformed cavities 112c, in the event there are multiple cavities). Although not shown, the medical device package 110 may be enclosed and sealed within an outer foil pouch.

During thermoforming of medical device packaging, the multi-layer polymer film 112 is heated to a softening temperature and one or more thermoformed cavities 112c of a given shape are thermoformed across the film. The resulting product (i.e., the multi-layer polymer film 112 with one or more cavities 112c formed therein) is also referred to herein as a thermoformed web.

In a typical process, a multi-layer polymer film is unwound from a roll and guided through a medical device packaging machine. The multi-layer polymer film is heated to reach an elevated temperature such that the multi-layer polymer film will soften and become pliable. The softened multi-layer polymer film is then blown or drawn into cavities in a mold by using a pressurized gas (e.g., compressed air, etc.) or vacuum, with or without plug assist, which will form one or more cavities in the multi-layer polymer film, thus creating a thermoformed web. The mold is typically cooled such that the multi-layer polymer film becomes sufficiently rigid so that the thermoformed web maintains its shape, allowing the thermoformed web to be removed from the mold. Medical device packaging machines are commonly supported web machines, meaning that the sides of the multi-layer polymer film are supported at points during the process, for example, with clamps or pins. One or more medical devices, medical device components, and/or medical device accessories, are then placed into the one or more cavities. Subsequently, a sealing station is used to seal the lidding onto the surface of the thermoformed web at a suitable temperature and pressure, which seals the desired product in the cavities. multi-layer polymer film thicknesses for processing into medical device packaging machines typically range from 200 microns or less to 2000 microns or more, for example, ranging from 200 to 400 to 600 to 800 to 100 to 1200 to 1400 to 2000 microns.

The present disclosure pertains to thermoformable, multi-layer films and thermoformed webs formed from such films having one or more thermoformed cavities contained therein, wherein multi-polymer film comprises a coextruded structure of at least two layers comprising a core layer and at least one outermost layer. The at least one outermost layer of the film is comprised of a polymer blend of (a) polyethylene (e.g. HDPE, LDPE or a combination of HDPE and LDPE), (b) a cyclic olefin copolymer, such as a copolymer of norbornene and ethylene or a copolymer of tetracyclododecene and ethylene, (c) functionalized polymers (e.g. functionalized HDPE, functionalized LDPE or a combination of functionalized HDPE and functionalized LDPE), such as maleic anhydride-functionalized HDPE, acrylic acid-functionalized HDPE, methacrylic acid-functionalized HDPE, glycidyl methacrylate-functionalized HDPE, maleic anhydride-functionalized LDPE, acrylic acid-functionalized LDPE, methacrylic acid-functionalized LDPE, and/or glycidyl methacrylate-functionalized LDPE, (d) a mineral filler, for example, a phyllosilicate mineral such as a clay mineral (e.g., kaolinite, montmorillonite, bentonite, illite, chlorite, etc.), a mica (e.g., muscovite, biotite, etc.), serpentine (e.g., chrysotile, etc.) or talc, and calcium carbonate, among others, and optionally, (e) a dispersing agent, for example, including but not limited to modified and unmodified polyolefin waxes. The core layer is comprised of a blend of HDPE and LDPE. In some embodiments, the HDPE may be a bimodal molecular weight HDPE. Where the multi-layer polymer film comprises two outermost layers (i.e., on opposing surface of the core layer), the two outermost layers may have the same composition or may have differing compositions. In certain preferred embodiments, the two outermost layers have the same composition.

As used herein, HDPE refers to polyethylene having a density of about 0.941 g/cm³ or above, whereas LDPE refers to polyethylene having a density of about 0.940 g/cm³ or below. In certain embodiments, the HDPE used herein has a density of 0.950 g/cm³ or more, or 0.960 g/cm³ or more. In certain embodiments, the HDPE used herein has a maximum density of 0.970 g/cm³. In certain embodiments, the HDPE used herein has a minimum density of 0.890 g/cm³. In certain embodiments, the LDPE used herein has a density of 0.930 g/cm³ or less, or 0.920 g/cm³ or less. In various embodiments, the total polyethylene content of the multi-layer polymer film will be at least 60% of the film's total weight. In various embodiments, the HDPE and the LDPE of the core layer are miscible, and the polyethylene, the cyclic olefin copolymer, and the functionalized polymers of the at least one outermost layer are miscible. In various embodiments, the blends of the at least one outermost layer and the core layer are homogeneous.

In embodiments, the thickness of the thermoformable, multi-layer film used to make blister packaging typically ranges from 40 microns or less to 550 microns or more, for example ranging from about 25 to 40 to 100 to 150 to 200 to 250 to 300 to 350 to 400 to 450 to 500 to 550 to 600 to 650 to 700 to 750 to 800 to 850 to 900 to 950 to 1000 to 1050 to 1100 to 1150 to 1200 to 1250 to 1300 to 1350 to 1400 to 1450 to 1500 to 1550 to 1600 to 1650 to 1700 to 1750 to 1800 to 1850 to 1900 to 1950 to 2000 microns. In embodiments, the thickness of the thermoformable, multi-layer film used to make medical device packaging typically ranges from about 200 microns or less to 2000 microns or more, for example, ranging from 200 to 400 to 600 to 800 to 100 to 1200 to 1400 to 1600 to 1800 to 2000 microns. In embodiments, the thickness of the film is reduced from the thermoforming process by 10%, 20%, 30%, or 40% to as low as 30 microns.

In various embodiments, the thermoformable, multi-layer film has a melting point ranging from 100 to 150° C. In embodiments, the thermoformable, multi-layer film has a total density below 1.0 g/cm³.

The presence of mineral filler in the at least one outermost layer (also called a “skin layer”) of the thermoformable, multi-layer film decreases the cycle time with which it takes to thermoform the film. Typically the at least one outermost layer will comprise between about 10% to 60% of the overall film thickness (this range refers to the combined thickness of the at least one outermost layer; thus, where two outermost layers are employed, each outermost layer will typically comprise from 5% to 30% of the overall film thickness) and the core layer will comprise between about 40 to 90% of the overall film thickness.

In some aspects, the present disclosure pertains to methods of forming a thermoformed web that has one or more thermoformed cavities contained therein. The thermoformed web is formed from a thermoformable, multi-layer film as detailed elsewhere herein. The methods comprise heating the multi-layer polymer film to a temperature whereby a softened polymer film is formed, and forcing the softened film into one or more cavities in a mold (e.g., by blowing the softened film into the one or more cavities using positive pressure, by drawing the softened film into the one or more cavities using a vacuum, with or without plug assist, etc.), thereby forming the one or more cavities. The multi-layer film is then cooled and removed from the mold.

In some embodiments, the thermoforming temperature of the multi-layer polymer film ranges from 90° C. to 150° C. (e.g., ranging from 90° C. to 100° C. to 110° C. to 120° C. to 130° C. to 140° C. to 150° C.), and preferably from 100° C. to 135° C. in certain embodiments.

In some embodiments, the thermoformed web is formed on an unsupported web machine and has a maximum shrinkage in any direction during processing in the range of +/−1%, +/−2%, +/−3%, +/−4%, or +/−5%. In some embodiments, the thermoformed web is formed on a supported web machine and has a maximum shrinkage in any direction during processing in the range of +/−1%, +/−2%, +/−3%, +/−4%, +/−5%, +/−6%, +/−7%, or +/−8%. As discussed below, the direction of greatest shrinkage is typically the direction transverse to the unwind, or machine, direction of the film.

In some aspects, the present disclosure pertains to blister packages that include (a) a thermoformed web that has one or more thermoformed blister cavities contained therein and is formed from a thermoformable, multi-layer film that comprises a core layer and at least one outermost layer as described in more detail elsewhere herein, (b) lidding applied to the thermoformed web, and (c) one or more consumable products positioned in the one or more thermoformed blister cavities and between the lidding and the thermoformed web. Examples of such consumable products include solid, semi-solid and liquid pharmaceutical dosage forms (e.g., tablets, pills, capsules, powders, gummies and syrups), food, and chewing gum, among others. In certain embodiments, the lidding is laid over and bonded to an area of the thermoformed web surrounding each blister cavity with a heat seal lacquer or polymeric seal layer. In certain embodiments, the lidding comprises a rupturable layer such as a rupturable foil layer, one or more layers of polymers, metals, or paper, among others, which may be scored in some cases to enhance rupture-ability. The lidding may also contain a burst resistant layer that provides burst security until it is removed. For example, the burst resistant layer may be a label adhered to an external surface of the rupturable layer.

In some aspects, the present disclosure pertains to medical device packages that include (a) a thermoformed web that has one or more thermoformed cavities contained therein and is formed from a thermoformable, multi-layer film that comprises a core layer and at least one outermost layer as described in more detail elsewhere herein, (b) lidding applied to the thermoformed web, and (c) one or more medical devices, medical device components and/or medical device accessories positioned in the one or more thermoformed cavities and between the lidding and the thermoformed web. Examples of such medical devices include, for example, orthopedic devices, catheters, injectables, surgical kits, and inhalers, among many others. In certain embodiments, the lidding is laid over and bonded to an area of the thermoformed web surrounding each cavity with a heat seal lacquer or other polymeric seal layer. In certain embodiments, the lidding comprises polymeric material and/or paper. Commonly used lidding materials are those that let gases pass but not germs. These materials include a spun bonded material formed from high-density polyethylene fibers (e.g., TYVEK) and special paper grades. The porosity of these materials enables sterilization by ethylene oxide and works by penetration of this gas through the lidding. In both cases, a peelable adhesive is typically used on the lidding, which is grid coated to let the gas pass as well. Alternatively, polymeric films are also available that can be sterilized by e-beam or gamma radiation. In some cases the medical device package may be enclosed and sealed within an outer foil pouch.

In various embodiments, the present disclosure is directed to processes that comprise (a) placing a product (e.g., consumer product, medical device, medical device component, medical device accessory, etc.) in a cavity of a thermoformed web that is formed from a multi-layer polymer film that comprises a core layer and at least one outermost layer as described elsewhere herein, and (b) sealing a lidding to the thermoformed web. In some embodiments, the lidding is sealed to the thermoformed web at an elevated sealing temperature. For example, the lidding may be attached to the thermoformed web at a sealing temperature ranging from 90 to 150° C., for example, ranging from 90° C. to 100° C. to 110° C. to 120° C. to 130° C. to 140° C. to 150° C.

### EXAMPLES

### Example 1

Skins were compounded in accordance with Table 1 where the cyclic olefin copolymer blend was a mixture of TOPAS® (Topas Advanced Polymers GmbH Corporation, Frankfurt, Germany) Cyclic Olefin Copolymer 8007F-04, having a glass transition temperature (Tg) of about 78° C., melt flow index (MFI) of about 1.9 g/10 min, and Topas Cyclic Olefin Copolymer 7010E-600, having a glass transition temperature (Tg) of about 110° C. and MFI of about 1.7 g/10 min. The functionalized polymer used was FUSABOND® (The Dow Chemical Company Corporation, Midland, Mich.) E204 Functional Polymer, having an MFI of about 12 g/10 min. The LLDPE (linear low density polyethylene) in this formulation was DOWLEX® (Dow Chemical Company, Midland, Mich.) 2035 Polyethylene Resin, having an MFI of about 6 g/10 min. A dispersing agent, for example polyolefin wax, was CERIDUST® (Clariant Produkte GmbH, Sulzbach, Germany) 3620. Finally the mineral filler was GLOMAX® (Imerys Kaolin, Inc. Corporation, Roswell, Ga.) XF.

TABLE 1
Skin Layer Formulation for Examples 1 and 4

| | |
|---|---|
| Cyclic Olefin Copolymer Blend | 75% |
| Functionalized polymer | 14% |
| Dispersing agent | 1% |
| Mineral Filler | 5% |
| LLDPE | 5% |

In the core formulation shown in Table 2, the HDPE used was the SURPASS® (NOVA Chemicals S.A., Fribourg, Switzerland) HPs167-AB Resin, having an MFI of around 1.2 g/10 min. The LLDPE was Dowlex 2035 Polyethylene Resin, having an MFI around 6 g/10 min.

TABLE 2
Core Layer Formulation

| | |
|---|---|
| HDPE | 80% |
| LLDPE | 20% |

### Example 2

In Example 2, skins were compounded in accordance with Table 3 where the cyclic olefin copolymer was Topas Cyclic Olefin Copolymer 8007F-600, having a glass transition temperature (Tg) of about 78° C., MFI of about 1.9 g/10 min. The functionalized polymers used was BYNEL® (The Dow Chemical Company Corporation, Midland, Mich.) 40E1053 Functional Polymer, having an MFI of about 2 g/10 min. The LLDPE (linear low density polyethylene) in this formulation was Dowlex 2047G Polyethylene Resin, having an MFI of about 2 g/10 min. A dispersing agent, for example polyolefin wax, was Ceridust 3620. Finally the mineral filler was Glomax XF.

TABLE 3
Skin Layer Formulation for Example 2

| | |
|---|---|
| Cyclic Olefin Copolymer | 75% |
| Functionalized polymer | 14% |
| Dispersing agent | 1% |
| Mineral Filler | 5% |
| LLDPE | 5% |

In the core formulation shown in Table 2, for example, the HDPE was the SURPASS HPs267-AB Resin, having an MFI of around 1.2 g/10 min. The LLDPE was Dowlex 2035 Polyethylene Resin, having an MFI around 6 g/10 min.

### Example 3

In Example 3, skins were compounded in accordance with Table 4 where the cyclic olefin copolymer was Topas Cyclic Olefin Copolymer 8007F-600, having a glass transition temperature (Tg) of about 78° C., melt flow index (MFI) of about 1.7 g/10 min. The functionalized polymer used was BYNEL 40E1053 Functional Polymer, having an MFI of about 2 g/10 min. The HDPE (high density polyethylene) in this formulation was Dowlex 667 Polyethylene Resin, having an MFI of about 6 g/10 min. A dispersing agent, for example polyolefin wax, was Ceridust 3620. Finally the mineral filler was Glomax XF.

TABLE 4
Skin Layer Formulation for Example 3

| | |
|---|---|
| Cyclic Olefin Copolymer | 75% |
| Functionalized polymer | 14% |
| Dispersing agent | 1% |
| Mineral Filler | 5% |
| HDPE | 5% |

In the core formulation shown in Table 2, the HDPE was the SURPASS HPs267-AB Resin, having an MFI of around 2 g/10 min. The LLDPE was Dowlex 2035 Polyethylene Resin, having an MFI around 6 g/10 min.

### Example 4

In Example 4, skins were compounded in accordance with Table 1 where the cyclic olefin copolymer was a mixture of Topas Cyclic Olefin Copolymer 8007F-04, having a glass transition temperature (Tg) of about 78° C., melt flow index (MFI) of about 1.9 g/10 min, and Topas Cyclic Olefin Copolymer 7010E-600, having a glass transition temperature (Tg) of about 110° C. and MFI of about 1.7 g/10 min. The functionalized polymer used was AMPLIFY® (The Dow Chemical Company, Midland, Mich.) EA 103 Functional Polymer, having an MFI of about 21 g/10 min. The LLDPE (linear low density polyethylene) in this formulation was Dowlex 2035 Polyethylene Resin, having an MFI of about 6 g/10 min. A dispersing agent, for example polyolefin wax, was Ceridust 3620. Finally the mineral filler was Glomax XF.

In the core formulation shown in Table 2, the HDPE was the SURPASS® HPs267-AB Resin, having an MFI of around 2 g/10 min. The LLDPE was Dowlex 2035 Polyethylene Resin, having an MFI around 6 g/10 min.

### Example 5

In Example 5, skins were compounded in accordance with Table 5 where the cyclic olefin copolymer was Topas Cyclic Olefin Copolymer 8007F-600, having a glass transition temperature (Tg) of about 78° C., melt flow index (MFI) of about 1.7 g/10 min. The functionalized polymer used was BYNEL 40E1053 Functional Polymer, having an MFI of about 2 g/10 min. The HDPE (high density polyethylene) in this formulation was Dowlex 667 Polyethylene Resin, having an MFI of about 6 g/10 min. A dispersing agent, for example polyolefin wax, was Ceridust 3620. Finally the mineral filler was a mixture of Glomax XF and OMYAFILM® (Omya AG Corporation, Oftringen/Argau, Switzerland) 792-FL.

TABLE 5
Skin Layer Formulation for Example 5

| | |
|---|---|
| Cyclic Olefin Copolymer | 72% |
| Functionalized polymer | 14% |
| Dispersing agent | 1% |
| Mineral Filler Mixture | 11% |
| HDPE | 2% |

In the core formulation shown in Table 2, the HDPE was the SURPASS HPs267-AB Resin, having an MFI of around 2 g/10 min. The LLDPE was Dowlex 2035 Polyethylene Resin, having an MFI around 6 g/10 min.

The skin and core formulations were compounded, separately, and then coextruded to form three layer films (10-30% Skin/80-40% Core/10-30% Skin) where the two outermost (skin) layers were of the same composition with the core being a different composition. The films tested were prepared using a lab-scale coextrusion setup that included two C.W. Brabender (South Hackensack, N.J., USA) ¾″ single screw extruders with an L/D of 25:1. A C.W. Brabender Intelli-Torque Plasti Corder torque rheometer was used as the drive unit on the main (core) extruder, while a C.W. Brabender ATR Plasti-Corder was used as the secondary (skin) extruder drive unit. The blend from the extruders was fed into an A/B/A feed block from C.W. Brabender which is then fed into a custom EDI® (Nordson Corporation, Westlake, Ohio) 12″ fish tail flex lip sheet die. The films are sent through a LabTech LCR-350-HD three roll stack (Labtech Engineering Company Ltd., Muang, Samutprakarn, Thailand) for gauge control and winding. Final thickness of the films ranged from 10 to 15 mil (254 to 381 micron).

The films were then tested on an Uhlmann B 1240 blister thermoforming line (Uhlmann Pac-Systeme GmbH & Co. KG, Laupheim, Germany) to quantify the performance of each film. The post-formation transverse direction (TD) shrinkage was recorded at several temperatures to measure dimensional stability of each film.

During the thermoforming process, which is an unsupported web process, films are heated and subsequently formed into a desired shape. This heating allows for the relaxation of the imparted thermal stresses which can result in shrinkage in the transverse direction (perpendicular to unwind direction). In addition to the thermal stresses, the tension from the thermoforming line on the heated film can also cause mechanical distortion which is exhibited by all thermoformable solids. This distortion may result in an elongation in the machine direction (parallel to the unwind direction) and, consequently, shrinkage in the transverse direction. Although tension contributes to transverse direction shrinkage, there is little tension on the film prior to shrinkage measurements, therefore the main driver is the relaxation of thermal stresses. In addition to transverse direction shrinkage, film can have a bias or asymmetric shrinkage which may cause the film to shift to one side or the other when processed on a blister line. This shifting can lead to defects in final parts and processing issues such as unformed cavities, “haloing”, and misalignment between forming, sealing, and cutting stations. Additionally, if the shrinkage is great enough that the tooling cannot properly clamp, none of the cavities will form, as air will escape from the areas where film has receded due to shrinkage. In addition to asymmetrical shrinkage, a film that shrinks past the clamping area can have the same effect. This means entire rolls of film could be unusable if the film shows consistent asymmetric shrinkage or too much shrinkage.

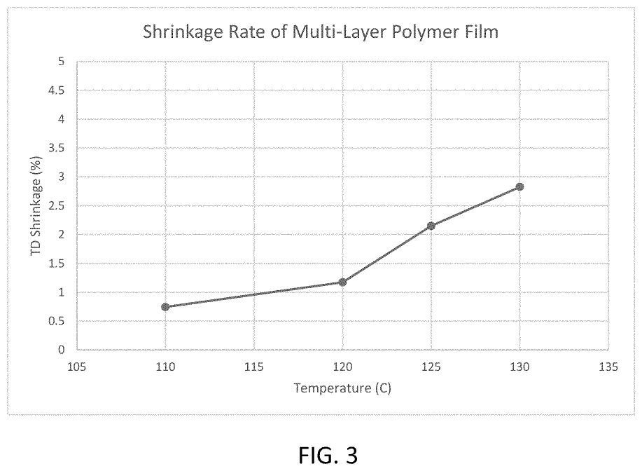

As shown in FIG. 3, films of the present disclosure exhibited an overall low shrinkage from the start of their thermoforming window up to a temperature of 115° C. Generally, a shrinkage of greater than 4% can cause issues on the Uhlmann B 1240 blister thermoforming line, making it unable to consistently produce blister cards, although this shrinkage value will greatly vary across lines (size, manufacturer, etc.). The thermoforming window exhibited by the polyethylene coextrusion in this study was 100° C. to 135° C., depending on the thermoforming line speed. For comparison, a standard PVC film (PENTAPHARM® PH-M570/01 at 250 microns, Klöckner Pentaplast Group, London, England) would possess a typical thermoforming window of approximately 110° C. to 140° C.

Samples without mineral fillers in the skin layers exhibited sticking to the contact heater at significantly lower temperatures than the samples with mineral fillers resulting in no discernable thermoforming window. In addition to sticking, almost all samples exhibited scalloping (increased shrinkage in the center of an index, but not at the ends) at or above 135° C.

Differential Scanning Calorimetry (DSC) is used to measure thermodynamic transitions such as glass transition temperature (T_{g}), crystallization temperature (T_{c}), and melting temperature (Tₘ). Each of these three temperatures measured using DSC plays a role in polymer processing and recycling. The glass transition temperature is the temperature at which the free volume between the polymer chains increases to the point that the polymer matrix allows the polymer chains to oscillate, with the volume of atoms being independent of temperature. From a practical standpoint, the glass transition temperature is the temperature at which amorphous regions of a polymer soften and are easily deformed. This softening caused by the glass transition signifies the start of the thermoforming range in amorphous polymers, including copolymers of ethylene and norbornene polymers. A polymer with a lower T_{g} is able to be thermoformed at lower temperatures which may lead to benefits during thermoforming such as shorter cycle times resulting from shorter heating times and lower energy costs due to the decreased heating requirements.

In addition to the glass transition temperature of amorphous polymers, other factors such as melting behavior of semicrystalline polymers (such as LDPE and HDPE) and thermal conductivity also influence the heating requirements for thermoforming. Semicrystalline polymers soften rapidly at the crystalline melting temperature. Although semicrystalline polymers must be softened with heat to become formable, the softening at the melting temperature tends to occur so rapidly that it is difficult to form these polymers due to the difficulty maintaining the perfect temperature in which these polymers are neither too rigid nor too soft to formed. Another difficulty that semicrystalline polymers suffer from in thermoforming is the high heat requirements to melt the crystalline domains. The high heat requirements cause semicrystalline polymers to suffer from higher than average cycle times due to the length of time required to heat and cool the polymer.

It is useful to know the crystallization behavior of polyethylene based polymers due to the distinct differences in properties that PE-based polymers show based on their level of crystallization. When PE-based polymers crystallize, the thermal stability and barrier properties of the polymer increases but the clarity of the polymer decreases. Highly crystalline polymers are generally too rigid to be formed by thermoforming unless the polymer temperatures near the crystalline melting temperature. Heating to the crystalline melting temperature allows for the crystalline domains to melt and allows for the polymer to soften to the point at which the polymer can be formed.

Examples of implementations of the invention described herein are for purposes of illustration only and are not to be taken as limiting the scope of the invention in any way. The scope of the invention is set forth in the following claims.

We claim:

1. A thermoformable multi-layer polymer film comprising:
(a) one or more outermost layers, each outermost layer comprising a first polymer blend that comprises
60 wt % to 90 wt % of a cyclic olefin copolymer having a glass transition temperature from 70° C. to 140° C. and a melt flow index (MFI) up to 100 g/10 min,
up to 25 wt % of a polyethylene having an MFI up to 30 g/10 min,
0.5 wt % to 30 wt % of a functionalized polymer having an MFI up to 50 g/10 min,
0.1 wt % to 15 wt % of a mineral filler, and
up to 15% of a dispersing agent; and
(b) a core layer comprising a second polymer blend that comprises
50 wt % to 95 wt % high density polyethylene having an MFI up to 30 g/10 min and,
5 wt % to 50 wt % low density polyethylene having an MFI up to 30 g/10 min.

2. The thermoformable multi-layer polymer film of claim 1, wherein the total content of the high density polyethylene and the low density polyethylene is greater than 50 wt % of the total mass of the multi-layer polymer film.

3. The thermoformable multi-layer polymer film of claim 1, wherein the cyclic olefin copolymer comprises less than 40 wt % of the total mass of the multi-layer polymer film.

4. The thermoformable multi-layer polymer film of claim 1, wherein the total density of the multi-layer polymer film is less than or equal to 1.0 g/cm³.

5. The thermoformable multi-layer polymer film of claim 1, wherein the multi-layer polymer film has a moisture vapor permeation rate below 350 g·μm/m²/day at 40° C. and 75% relative humidity as measured according to ASTM F-1249 method.

6. The thermoformable multi-layer polymer film of claim 1, wherein the multi-layer polymer film comprises said core layer disposed between two of said outermost layers.

7. The thermoformable multi-layer polymer film of claim 1, wherein the cyclic olefin copolymer is a copolymer of norbornene and ethylene and has a glass transition temperature ranging from 60 to 140° C. as measured by differential scanning calorimetry.

8. The thermoformable multi-layer polymer film of claim 1, wherein the multi-layer polymer film ranges from 25 microns to 2000 microns in total thickness.

9. The thermoformable multi-layer polymer film of claim 1, where the multi-layer polymer film is formed by extruding at least said first and second polymer blends in a sheet having two or more layers.

10. A thermoformed web made from the thermoformable multi-layer polymer film of claim 1.

11. A method of forming a thermoformed web made from the thermoformable multi-layer polymer film of claim 1, the method comprising heating the multi-layer polymer film to a temperature whereby the multi-layer polymer film is softened, and forcing the softened film into one or more mold cavities of a mold to form one or more thermoformed cavities.

12. The method of claim 11, wherein the multi-layer polymer film is heated to a temperature ranging from 100 to 135° C. throughout its cross section.

13. The method of claim 11, wherein the thermoformed web is formed on an unsupported machine and the multi-layer polymer film has a maximum shrinkage rate of up to 8% in any direction.

14. A packaged product comprising the thermoformed web formed by the method of claim 11, further comprising lidding applied to the thermoformed web, and one or more products positioned in the one or more thermoformed cavities and between the lidding and the thermoformed web.

15. The packaged product of claim 14, wherein a thickness of the multi-layer polymer film ranges from 40 to 550 microns.

16. The packaged product of claim 14, wherein the lidding comprises a rupturable layer and a burst resistant layer that can be removed from the rupturable layer, a rupturable layer that can be opened by pressure on an opposite side of the packaged product, or a peelable layer that can be removed from the thermoformed web giving access to the one or more products.

17. A process of forming the packaged product of claim 14, comprising (a) positioning the one or more products in the one or more thermoformed cavities of the thermoformed web and (b) sealing lidding to the thermoformed web thereby enclosing the one or more products in the one or more thermoformed cavities.

18. The process of claim 17, wherein the lidding is sealed to the thermoformed web at a sealing temperature ranging from 90° C. to 150° C.
